(19) United States
(12) Patent Application Publication
(10) Pub. No.: US 2020/0236906 A1
(43) Pub. Date: Jul. 30, 2020

(54) Removable Sleeved Dog Coat

(71) Applicant: Gail Koback, Bluebell, PA (US)

(72) Inventor: Gail Koback, Bluebell, PA (US)

(21) Appl. No.: 16/260,300

(22) Filed: Jan. 29, 2019

(51) Int. Cl. A01K 13/00

(52) U.S. Cl. CPC A01K 13/006

(57) ABSTRACT

A removable sleeved dog coat for easily adding or removing sleeves to improve pet comfort includes a body stocking having a top side, a left side, a right side, a head aperture, a pair of leg apertures, and a rear aperture. The top side has a zip aperture extending from the head aperture to the rear aperture. The body stocking is configured to be worn on the torso of a dog. A principal zipper is coupled to the zip aperture to open and close the zip aperture. A first attachment mechanism is coupled to the body stocking adjacent the pair of leg apertures and the rear aperture. A pair of rear leg sleeves each has a second attachment mechanism that is selectively engageable with the first attachment mechanism adjacent the rear aperture. The pair of rear leg sleeves is configured to be worn on the rear legs of the dog.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to dog coats and more particularly pertains to a new dog coat for easily adding or removing sleeves to improve pet comfort.

### BRIEF SUMMARY OF THE INVENTION

An embodiment of the disclosure meets the needs presented above by generally comprising a body stocking having a top side, a left side, a right side, a head aperture, a pair of leg apertures, and a rear aperture. The top side has a zip aperture extending from the head aperture to the rear aperture. The body stocking is configured to be worn on the torso of a dog with the front legs through the pair of leg apertures and the head through the head aperture. A principal zipper is coupled to the zip aperture to open and alternatively close the zip aperture. A first attachment mechanism is coupled to the body stocking adjacent the pair of leg apertures and the rear aperture. A pair of rear leg sleeves each has a second attachment mechanism that is selectively engageable with the first attachment mechanism adjacent the rear aperture. The pair of rear leg sleeves is configured to be worn on the rear legs of the dog.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric in-use view of a removable sleeved dog coat according to an embodiment of the disclosure.

FIG. 2 is an isometric view of an embodiment of the disclosure.

FIG. 3 is a side elevation in-use view of an embodiment of the disclosure.

FIG. 4 is a cross-sectional view of an embodiment of the disclosure along line 4-4 of FIG. 2.

FIG. 5 is an isometric in-use view of an embodiment of the disclosure.

### DETAILED DESCRIPTION OF THE INVENTION

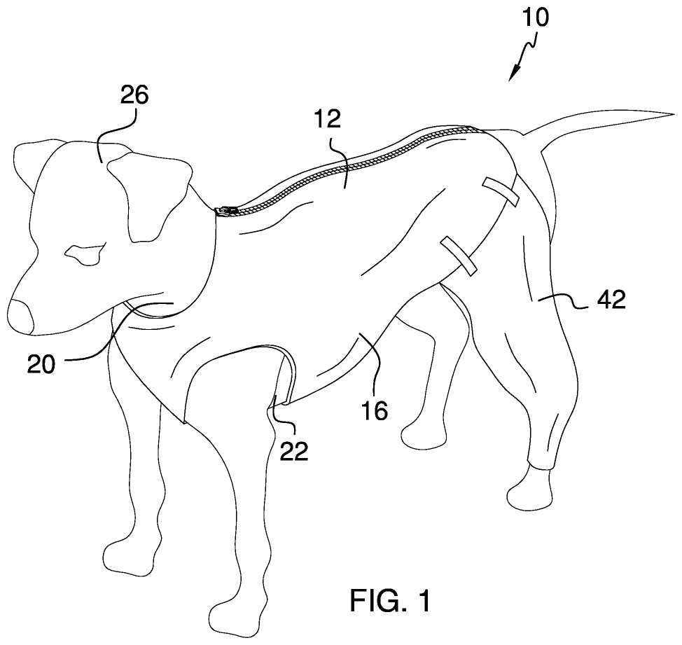

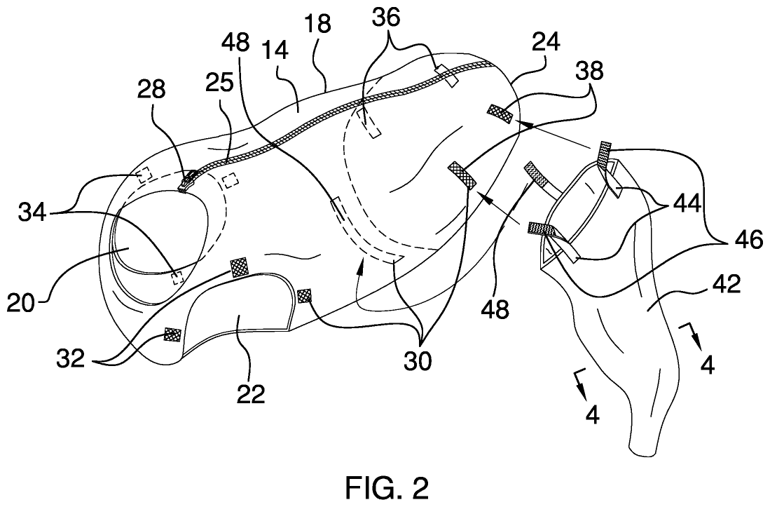

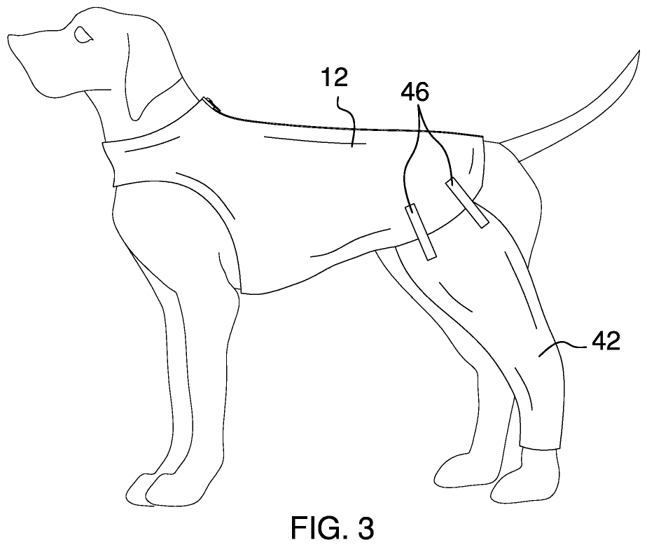

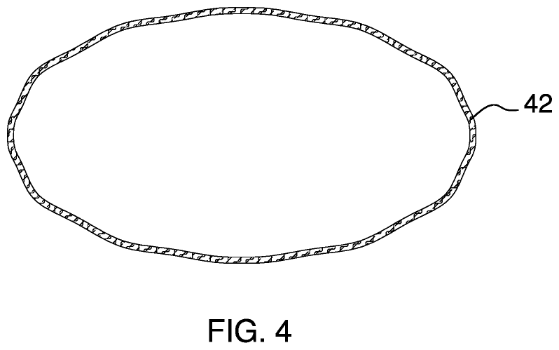

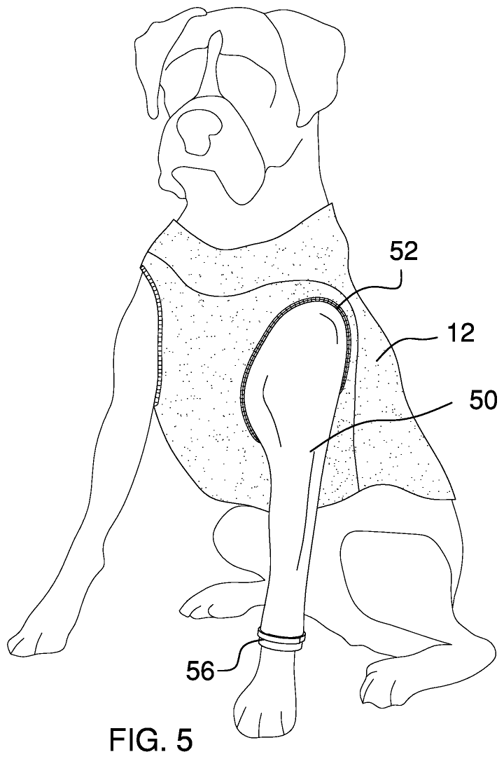

With reference now to the drawings, and in particular to FIGS. 1 through 5 thereof, a new dog coat embodying the principles and concepts of an embodiment of the disclosure and generally designated by the reference numeral 10 will be described.

As best illustrated in FIGS. 1 through 5, the removable sleeved dog coat 10 generally comprises a body stocking 12 having a top side 14, a left side 16, a right side 18, a head aperture 20, a pair of leg apertures 22, and a rear aperture 24. The top side 14 has a zip aperture 25 extending from the head aperture 20 to the rear aperture 24. The body stocking 12 is configured to be worn on the torso of a dog 26 with the front legs through the pair of leg apertures 22 and the head through the head aperture 20. The body stocking 12 may be a stretchable knit material that is configured to hug the torso of the dog 26 and to stretch with the dog's movements. A principal zipper 28 is coupled to the zip aperture 25 to open and alternatively close the zip aperture 25.

A first attachment mechanism 30 is coupled to the body stocking 12. The first attachment mechanism 30 may comprise a set of four left front attachments 32 and a set of four right front attachments 34 coupled adjacent the pair of leg apertures 22 and a pair of right rear attachments 36, a pair of left rear attachments 38, and a rear underbelly attachment 40 coupled adjacent the rear aperture 24.

A pair of rear leg sleeves 42 each has a second attachment mechanism 44. The second attachment mechanism 44 may comprise a pair of outer straps 46 to engage either the pair of right rear attachments 36 or the pair of left rear attachments 38 and an inner strap 48 to engage the rear underbelly attachment 40. The pair of rear leg sleeves 42 is configured to be worn on the rear legs of the dog 26. A pair of front leg sleeves 50 each has a third attachment mechanism 52. The third attachment mechanism 52 may be a set of four front sleeve attachments 54 to engage either the set of four right front attachments 34 or the set of four left front attachments 32. The pair of front leg sleeves 50 is configured to be worn on the front legs of the dog 26. Each of the first attachment mechanism 30, the second attachment mechanism 44, and the third attachment mechanism 52 is either a hook-and-loop fastener or a zipper. There may be a plurality of foot straps 56 coupled to each of the pair of rear leg sleeves 42 and the pair of front leg sleeves 50. Each of the plurality of foot straps 56 is configured to adjustably secure proximal the paws of the dog and may be a hook-and-loop fastener. Each of the pair of rear leg sleeves 42 and the pair of front leg sleeves 50 has a double-walled construction.

In use, the body stocking 12 is placed on the dog and the principal zipper 28 is closed. Each of the pair of rear leg sleeves 42 and the pair of front leg sleeves 50 may then be added or removed as desired to maximize the comfort of the dog 26 depending on weather conditions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A removable sleeved dog coat comprising:
a body stocking, the body stocking having a top side, a left side, a right side, a head aperture, a pair of leg apertures, and a rear aperture, the top side having a zip aperture extending from the head aperture to the rear aperture, the body stocking being configured to be worn on the torso of a dog with the front legs through the pair of leg apertures and the head through the head aperture;
a principal zipper coupled to the body stocking, the principal zipper being coupled to the zip aperture to open and alternatively close the zip aperture;
a first attachment mechanism coupled to the body stocking, the first attachment mechanism being coupled adjacent the pair of leg apertures and the rear aperture; and
a pair of rear leg sleeves, each of the pair of rear leg sleeves having second attachment mechanism, the second attachment mechanism being selectively engageable with the first attachment mechanism adjacent the rear aperture, the pair of rear leg sleeves being configured to be worn on the rear legs of the dog.

2. The removable sleeved dog coat of claim 1 further comprising a pair of front leg sleeves, each of the pair of front leg sleeves having a third attachment mechanism, the third attachment mechanism being selectively engageable with the first attachment mechanism adjacent the pair of leg apertures, the pair of front leg sleeves being configured to be worn on the front legs of the dog.

3. The removable sleeved dog coat of claim 2 further comprising the first attachment mechanism comprising a pair of right rear attachments, a pair of left rear attachments, a rear underbelly attachment, a set of four left front attachments, and a set of four right front attachments, the second attachment mechanism comprising a pair of outer straps to engage either the pair of right rear attachments or the pair of left rear attachments and an inner strap to engage the rear underbelly attachment, the third attachment mechanism being a set of four front sleeve attachments to engage either the set of four right front attachments or the set of four left front attachments.

4. The removable sleeved dog coat of claim 3 further comprising each of the first attachment mechanism, the second attachment mechanism, and the third attachment mechanism being hook-and-loop fasteners.

5. The removable sleeved dog coat of claim 3 further comprising each of the first attachment mechanism, the second attachment mechanism, and the third attachment mechanism being snaps.

6. The removable sleeved dog coat of claim 2 further comprising each of the first attachment mechanism, the second attachment mechanism, and the third attachment mechanism being zippers.

7. The removable sleeved dog coat of claim 2 further comprising a plurality of foot straps coupled to each of the pair of rear leg sleeves and the pair of front leg sleeves, each of the plurality of foot straps being configured to adjustably secure proximal the paws of the dog.

8. The removable sleeved dog coat of claim 7 further comprising the foot strap being an adjustable hook-and-loop fastener.

9. The removable sleeved dog coat of claim 2 further comprising the body stocking being a stretchable knit material, the stretchable knit material being configured to hug the torso of the dog and to stretch with the dog's movements.

10. The removable sleeved dog coat of claim 2 further comprising each of the pair of rear leg sleeves and the pair of front leg sleeves having a double-walled construction.

11. A removable sleeved dog coat comprising:
a body stocking, the body stocking having a top side, a left side, a right side, a head aperture, a pair of leg apertures, and a rear aperture, the top side having a zip aperture extending from the head aperture to the rear aperture, the body stocking being configured to be worn on the torso of a dog with the front legs through the pair of leg apertures and the head through the head aperture, the body stocking being a stretchable knit material, the stretchable knit material being configured to hug the torso of the dog and to stretch with the dog's movements;
a principal zipper coupled to the body stocking, the principal zipper being coupled to the zip aperture to open and alternatively close the zip aperture;
a first attachment mechanism coupled to the body stocking, the first attachment mechanism comprising a set of four left front attachments and a set of four right front attachments coupled adjacent the pair of leg apertures and a pair of right rear attachments, a pair of left rear attachments, and a rear underbelly attachment coupled adjacent the rear aperture;
a pair of rear leg sleeves, each of the pair of rear leg sleeves having second attachment mechanism, the second attachment mechanism comprising a pair of outer straps to engage either the pair of right rear attachments or the pair of left rear attachments and an inner strap to engage the rear underbelly attachment, the pair of rear leg sleeves being configured to be worn on the rear legs of the dog;
a pair of front leg sleeves, each of the pair of front leg sleeves having a third attachment mechanism, the third attachment mechanism being a set of four front sleeve attachments to engage either the set of four right front attachments or the set of four left front attachments, the pair of front leg sleeves being configured to be worn on the front legs of the dog;
a plurality of foot straps coupled to each of the pair of rear leg sleeves and the pair of front leg sleeves, each of the plurality of foot straps being configured to adjustably secure proximal the paws of the dog;
wherein each of the first attachment mechanism, the second attachment mechanism, the third attachment mechanism, and the foot strap is a hook-and-loop fastener, wherein each of the pair of rear leg sleeves and the pair of front leg sleeves has a double-walled construction.

12. A removable sleeved dog coat comprising:
a body stocking, the body stocking having a top side, a left side, a right side, a head aperture, a pair of leg apertures, and a rear aperture, the top side having a zip aperture extending from the head aperture to the rear aperture, the body stocking being configured to be worn on the torso of a dog with the front legs through the pair of leg apertures and the head through the head aperture, the body stocking being a stretchable knit material, the stretchable knit material being configured to hug the torso of the dog and to stretch with the dog's movements;
a principal zipper coupled to the body stocking, the principal zipper being coupled to the zip aperture to open and alternatively close the zip aperture;
a first attachment mechanism coupled to the body stocking, the first attachment mechanism being coupled adjacent the pair of leg apertures and the rear aperture;
a pair of rear leg sleeves, each of the pair of rear leg sleeves having second attachment mechanism, the second attachment mechanism being selectively engageable with the first attachment mechanism adjacent the rear aperture, the pair of rear leg sleeves being configured to be worn on the rear legs of the dog;
a pair of front leg sleeves, each of the pair of front leg sleeves having a third attachment mechanism, the third attachment mechanism being selectively engageable with the first attachment mechanism adjacent the pair of leg apertures, the pair of front leg sleeves being configured to be worn on the front legs of the dog; and
a plurality of foot straps coupled to each of the pair of rear leg sleeves and the pair of front leg sleeves, each of the plurality of foot straps being configured to adjustably secure proximal the paws of the dog;
wherein each of the first attachment mechanism, the second attachment mechanism, and the third attachment mechanism is a zipper and each of the plurality of foot straps is a hook-and-loop fastener, wherein each of the pair of rear leg sleeves and the pair of front leg sleeves has a double-walled construction.
